(19) United States
(12) Patent Application Publication
(10) Pub. No.: US 2017/0101941 A1
(43) Pub. Date: Apr. 13, 2017

(54) METHOD AND DEVICE FOR DIAGNOSING A VARIABLE SETTING OF A COMPRESSION RATIO IN A RECIPROCATING INTERNAL COMBUSTION ENGINE

(71) Applicant: Robert Bosch GmbH, Stuttgart (DE)

(72) Inventors: Pascal Gladel, Ludwigsburg (DE); Armin Hassdenteufel, Sachsenheim-Ochsenbach (DE); Bernd Kesch, Hemmingen (DE); Holger Jessen, Ludwigsburg (DE)

(21) Appl. No.: 15/289,431

(22) Filed: Oct. 10, 2016

Related U.S. Application Data
(60) Provisional application No. 62/240,356, filed on Oct. 12, 2015.

(30) Foreign Application Priority Data
Nov. 6, 2015 (DE) 102015221809.0

(51) Int. Cl. F02D 15/02; F02D 41/14; F02D 41/26; F02D 35/00

(52) U.S. Cl. CPC F02D 15/02; F02D 35/0015; F02D 41/1454; F02D 41/26; F02D 2200/0802; F02D 2200/101

(57) ABSTRACT

A method for diagnosing a variable setting of a compression ratio in a reciprocating internal combustion engine, an error of the variable setting of the compression ratio, being signaled as a function of a measured state variable of the exhaust gas system, in particular a measured exhaust gas temperature.

### FIELD OF THE INVENTION

The present invention relates to internal combustion engines, in particular reciprocating internal combustion engines including VCR actuators (VCR: variable compression ratio), which make a variable adaptation of a compression ratio of combustion chambers of the internal combustion engine possible. Furthermore, the present invention relates to a method for diagnosing VCR actuators.

### BACKGROUND INFORMATION

For reciprocating internal combustion engines, there exists the possibility for setting a compression ratio in the combustion chambers of the cylinders using various measures. The compression ratio indicates a ratio between a maximum volume of the combustion chamber and a minimum volume of the combustion chamber during a power cycle of the internal combustion engine. The compression ratio may be set variably using suitable, so-called VCR actuators.

For example, a reciprocating internal combustion engine having variable compression and including an actuation unit for changing a compression ratio is known from WO 2014/019684. The actuation unit includes a connecting rod having a variable length, a piston having a variable compression height and/or a crankshaft having a variable crankshaft radius.

Furthermore, a setting device for a crankshaft of an internal combustion engine is discussed in DE 10 2008 050 827 A1. The crankshaft is supported in adjusting bearings, which may be set using a setting shaft in order to change the position of the crankshaft between a minimum compression position and a maximum compression position of a piston in a cylinder.

Furthermore, a device for setting a variable compression ratio in an internal combustion engine is discussed in US 2014/0014071. The device includes an eccentric bearing assembly for accommodating the crankshaft. The eccentric bearing assembly includes a rotatable eccentric ring in which the crankshaft is supported, it being possible to set the compression ratio by rotating the eccentric ring.

The possibility of setting the compression variably influences the consumption and consequently the exhaust gas emissions. Thus, a system for setting a variable compression is diagnosis-relevant according to the OBD legislation and the implementation of a specification of the compression ratio to the VCR actuator must be monitored during engine operation.

A method for monitoring the function of a device for variably setting the cylinder compression in a reciprocating internal combustion engine is known from DE 199 55 250 A1, an engine operating parameter, which responds to a change of the cylinder compression being ascertained in each case before and after an activation of the device for changing the cylinder compression and both values of the engine operating parameter being compared with one another. This makes it possible to determine if a change of the engine operating parameter has occurred, a change of the engine operating parameter being an indication for a correct function of the device for variably setting the cylinder compression. The change in compression may be detected with the aid of the rough engine run or with the aid of variables measured by a combustion chamber pressure sensor or a torque sensor or an intake manifold pressure sensor.

### SUMMARY OF THE INVENTION

According to the present invention, a method for diagnosing a variable setting of a compression ratio in a reciprocating internal combustion engine is provided according to the main description herein and the device and the engine system are provided according to the other descriptions herein.

Additional embodiments are provided in the further descriptions herein.

According to a first aspect, a method is provided for diagnosing a variable setting of a compression ratio in a reciprocating internal combustion engine, an error of the variable setting of the compression ratio being signaled as a function of a measured state variable of the exhaust gas system, in particular a measured exhaust gas temperature.

Furthermore, the following steps may be provided:
measuring the exhaust gas state variable in a determined or instantaneous compression ratio in a predefined operating state of the internal combustion engine;
modeling the exhaust gas state variable for the determined or instantaneous compression ratio in the predefined operating state; and
signaling an error of the variable setting of the compression ratio as a function of a difference between the measured exhaust gas state variable and the modeled exhaust gas temperature.

Alternatively, the following steps may be provided:
measuring the exhaust gas state variable in a predefined first compression ratio and in a predefined second compression ratio;
ascertaining a difference between the measured exhaust gas state variables; and
signaling an error of the variable setting of the compression ratio as a function of the ascertained difference between the measured exhaust gas state variables.

Internal combustion engines having a possibility of setting a variable compression, for example using so-called VCR actuators, make it possible to reduce the fuel consumption, in that the charge-exchange losses are optimized by setting a compression ratio in the combustion chambers of the cylinders. In order to achieve the highest possible efficiency with regard to the obtained mechanical energy, the compression ratio in ongoing operation, i.e., in normal operation, is usually selected as high as possible, i.e., close to the knock limit. The general goal in the operation of internal combustion engines using a variable compression ratio is to set the compression ratio in such a way that the best possible overall efficiency results at low knocking tendency, so that the internal combustion engine may be operated at optimal fuel consumption while running very smoothly.

For diagnosing the VCR actuator, the above method provides for evaluating an exhaust gas temperature as an exhaust gas state variable as a variable characterizing the combustion exhaust gases emitted by the internal combustion engine. The set compression ratio influences the input of energy into the exhaust discharge system and consequently the combustion exhaust gases. The improvement in efficiency of the combustion using an increased compression ratio therefore results in a lower input of energy into the exhaust discharge system and consequently lower exhaust gas temperatures compared to a lower compression ratio.

In modern engine control units, models are generally implemented in order to determine arithmetically to an exhaust gas temperature as a function of influencing engine variables. This exhaust gas temperature model may be expanded to include the influence of the compression ratio. Temperature sensors are also generally located in the exhaust gas system in order to measure the temperature of the combustion exhaust gases. Consequently, it is possible to compare the modeled exhaust gas temperature ascertained with the aid of the exhaust gas temperature model and the measured exhaust gas temperature with one another and in this way determine or plausibilize the set compression ratio.

Furthermore, it is possible to model the exhaust gas temperature for the determined or instantaneous compression ratio in the predefined operating state based on a predefined exhaust gas temperature model, the exhaust gas temperature model including one or multiple of the following parameters as input variables:
an ignition angle or an ignition point;
an engine speed;
an air charge;
an air-fuel ratio in the cylinders of the internal combustion engine;
an exhaust gas mass flow;
an ambient temperature;
an ambient pressure;
a cooling rate of the exhaust gas between exit from the exhaust valve and the temperature sensor; and
the determined or instantaneous compression ratio.

Alternatively, the measured exhaust gas state variable may correspond to a lambda value of the combustion exhaust gas in the exhaust discharge system.

It may be provided that the method is carried out when release conditions are satisfied, the release conditions including one or multiple of the following:
the temperature of the internal combustion engine is higher than a predefined threshold temperature;
the internal combustion engine is operated at a predefined operating point or in a predefined operating range, the operating point in particular being predefined by a certain speed and/or engine load or the operating range in particular being predefined by a certain speed range and/or engine load range;
the internal combustion engine is operated at a static operating point; and
The VCR actuator is ready for operation.

According to another aspect, a device is provided for diagnosing a variable setting of a compression ratio in a reciprocating internal combustion engine, the device being configured for carrying out the above method.

According to another aspect, an engine system including an internal combustion engine including a VCR actuator and the above device is provided.

Specific embodiments are elucidated in greater detail in the following with reference to the appended drawings.

### BRIEF DESCRIPTION OF THE DRAWINGS

FIG. 1 shows a schematic representation of an engine system including an internal combustion engine, which includes a VCR actuator for setting a variable compression ratio in the combustion chambers of the cylinders.

FIG. 2 shows a diagram for illustrating the dependence between the compression ratio, the thermal efficiency and the isentropic exponent in an exemplary internal combustion engine.

FIG. 3 shows a flow chart for illustrating a method for diagnosing a VCR actuator in an internal combustion engine.

FIG. 4 shows a flow chart for illustrating another method for diagnosing a VCR actuator in an internal combustion engine.

### DETAILED DESCRIPTION

FIG. 1 shows a schematic representation of an engine system 1 including an internal combustion engine 2, which is configured in the form of a reciprocating internal combustion engine. Internal combustion engine 2 may be configured, for example, in the form of a gasoline engine or diesel engine.

Internal combustion engine 2 has cylinders 3 which include combustion chambers 31, in which a piston 4 is movably situated in a manner known per se. On its side diametrically opposed to combustion chamber 31, piston 4 is coupled with a crankshaft 5 via a connecting rod (not shown), so that a stroke movement of piston 4 caused by a combustion cycle in internal combustion engine 2 is converted into a rotational movement of crankshaft 5.

Internal combustion engine 2 is otherwise configured like a conventional reciprocating internal combustion engine. Fresh air is supplied to internal combustion engine 2 via an air guidance system 7 and combustion exhaust gases are discharged from cylinders 3 via an exhaust discharge system 8.

An exhaust gas aftertreatment unit 11, for example, in the form of a catalytic converter or the like, may be provided in exhaust discharge system 8. A temperature sensor 12 may be situated between the exhaust valves (not shown) and exhaust gas aftertreatment unit 11, in order to measure an exhaust gas temperature 12. Temperature sensor 12 may be situated close to the exhaust valves in order to reduce the influence of cooling by the ambient temperature. Alternatively, the temperature sensor may also be situated at the location of a lambda sensor (not shown), which makes it possible to simplify its installation.

The coupling between crankshaft 5 and piston 4 in cylinders 3 may be provided using a VCR actuator 6 (VCR: variable compression ratio) known per se, in order to variably set a compression ratio in cylinders 3. The compression ratio corresponds to a ratio of a maximum volume of combustion chamber 31 of cylinder 3, i.e., the volume of combustion chamber 31 when piston 4 is located on a bottom dead center of the piston movement, to a minimum volume of combustion chamber 31 of cylinder 3, i.e., a volume of combustion chamber 31 when piston 4 is located on a top dead center of the piston movement. Common to all types of VCR actuators 6 is that the position of piston 4 on the top dead center changes as a function of the compression ratio to be set. In the case of certain variants of VCR actuators, the position of piston 4 on the bottom dead center may also be a function of the compression ratio to be set. In particular, the higher the compression ratio is set, the closer the top dead center lies to a combustion chamber dome 16 of combustion chamber 31.

Internal combustion engine 2 is operated by a control unit 10 in a manner known per se. In addition to the setting possibilities provided for operating a conventional internal combustion engine 2, control unit 10 may also set VCR actuator 6, so that the compression ratio is selected variably.

One advantage of being able to set compression ratio ε results from the dependence of thermal efficiency η_{TH} of an internal combustion engine on compression ratio ε, as follows:

$${η}_{TH} = 1 - {( \frac{1}{ɛ} )}^{K - 1}$$

ε describes the compression ratio, which usually lies between 8 and 14 in gasoline engines, and κ describes the isentropic exponent of the mixture, which may be assumed to be approximately 1.3 for a homogeneous combustion. Consequently, thermal efficiency η_{TH} is increased by approximately 10% across the entire setting range of the compression ratio if the compression ratio is increased from a minimum value to a maximum value. This may result in a reduction of the fuel consumption of the internal combustion engine.

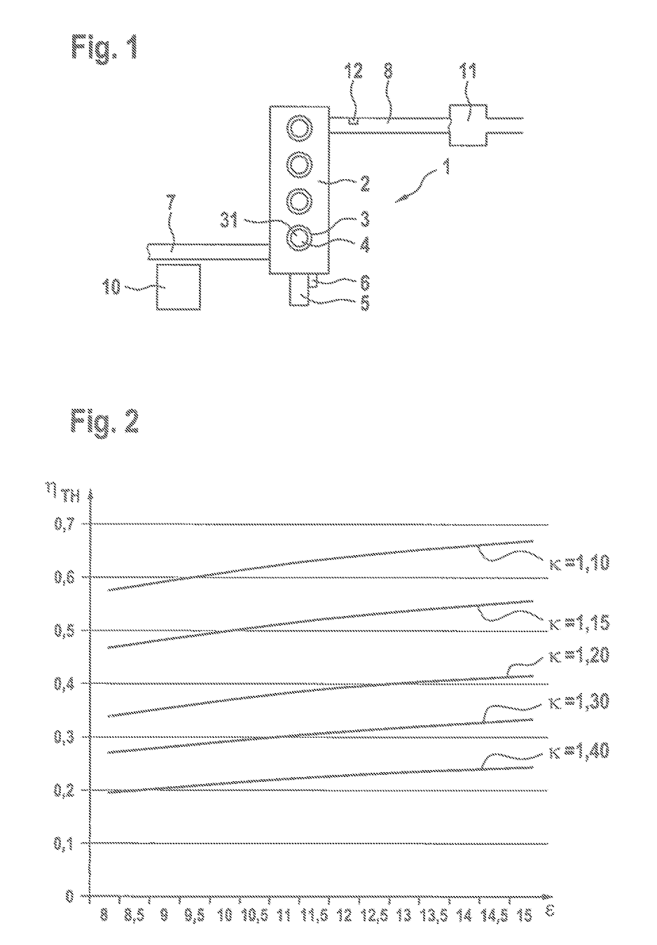

The isentropic exponent is dependent on the degree of freedom of the gas molecules of the air-fuel mixture. Thus, among other things, the water content of the air taken in and the ratio between the air taken in and the fuel, generally indicated by the lambda value, play a role. In particular, if there is a large quantity of polyatomic molecules, the isentropic exponent is also very temperature-dependent, since only at higher temperatures are the rotational and vibrational degrees of freedom of the polyatomic molecules more strongly excited. This results in thermal efficiency η_{TH} as a function of compression ratio ε as well as of parameters such as an intake air temperature, an intake air humidity and an air-fuel ratio Λ. FIG. 2 shows, by way of example, the curve of thermal efficiency η_{TH} as a function of compression ratio ε for different isentropic exponents.

Based on the thermal efficiency as a function of the compression ratio, the exhaust gas temperature varies in the case of changing compression ratios. In particular, the exhaust gas temperature may vary between 80-150° C. between a minimum compression ratio and a maximum compression ratio.

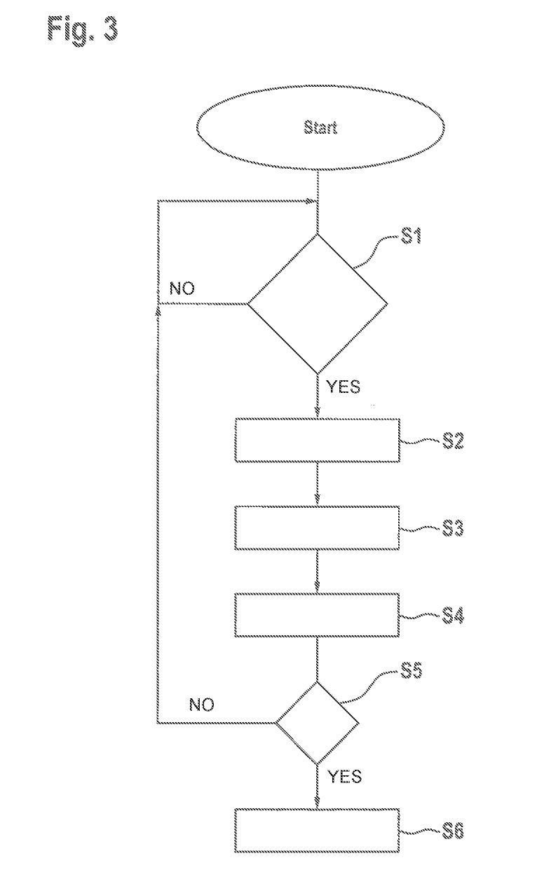

Based on the dependence of the efficiency on the compression ratio, this is also relevant for the exhaust gas emissions. Consequently, the VCR actuator is also subject to the exhaust gas emissions legislation for motor vehicles and must be checked for its proper functioning on a regular basis. For that purpose, a diagnostic method is provided, as is shown in the flow chart of FIG. 3.

In step S1, it is first checked if the release conditions for carrying out a diagnosis of the VCR actuator have been satisfied. One or multiple of the following aspects may be checked as release conditions:
The temperature of the internal combustion engine is higher than a predefined threshold temperature. This ensures that the diagnosis is only carried out if the engine is at operating temperature.
The internal combustion engine is operated at a certain operating point or in a certain operating range, which is predefined by a certain speed, engine load and the like.
The internal combustion engine is operated at a static operating point, i.e., the engine dynamics are 0 or a low amount. This may, for example, be ensured in that the engine torque gradient is smaller than a predefined gradient threshold value.
The VCR actuator is ready for operation.
The exhaust gas temperature sensor is ready for operation.

If the release condition or release conditions have been satisfied (alternative: yes), the method is continued to step S2; otherwise (alternative: no), the method steps back to step S1.

In step S2, the exhaust gas temperature is measured, for example, with the aid of temperature sensor 12 in the exhaust discharge system.

In step S3, an exhaust gas temperature is ascertained from operating variables with the aid of an exhaust gas temperature model. Modeling the exhaust gas temperature from operating variables is known per se and is expanded for the present method by including the influence of the compression ratio. For example, the exhaust gas temperature model may be provided in the form of a characteristic diagram, into which one or multiple of the following variables are entered as input variables:
ignition angle or ignition point;
engine speed;
air charge;
lambda value or air-fuel ratio in the cylinders;
exhaust gas mass flow;
ambient temperature;
ambient pressure;
cooling of the exhaust gas between exit from the exhaust valve and temperature sensor 12;
the compression ratio, which is predefined by VCR actuator 6 for the setting; and
vehicle speed.

In particular, it may be adequate to calculate the exhaust gas temperature with the aid of the exhaust gas temperature model using the input variables exhaust gas mass flow, compression ratio and engine speed. This makes it possible to model the exhaust gas temperature at a precision of approximately 10-30° C.

In step S4, the measured exhaust gas temperature and the modeled exhaust gas temperature are compared.

In step S5, it is checked if the measured exhaust gas temperature deviates from the modeled exhaust gas temperature by more than a predetermined tolerance amount. If this is the case (alternative: yes), an error of the VCR actuator is signaled in step S6. Otherwise (alternative: no), the method steps back to step S1.

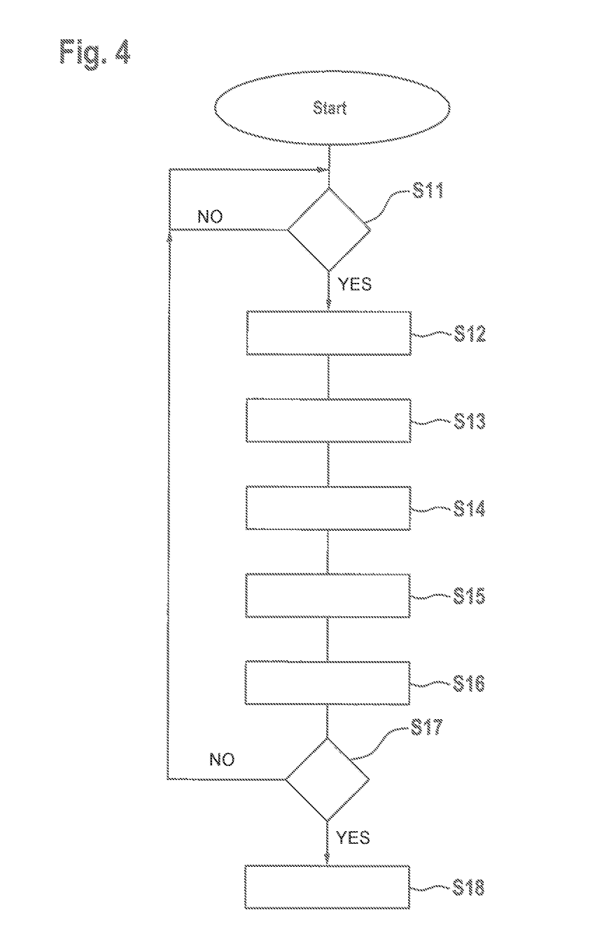

A flow chart for illustrating another method for carrying out a diagnosis of VCR actuator 6 is shown in FIG. 4.

In step S11, as in step S1, it is first checked if the release conditions for carrying out a diagnosis of the VCR actuator have been satisfied.

If the release condition or release conditions have been satisfied (alternative: yes), the method is continued to step S12; otherwise (alternative: no), the method steps back to step S11.

In step S12, a predetermined first compression ratio is set.

In step S13, the exhaust gas temperature at the predetermined first compression ratio is measured, for example, with the aid of temperature sensor 12 in the exhaust discharge system.

In step S14, the compression ratio is set to a predetermined second compression ratio.

In step S15, the exhaust gas temperature is measured at the predetermined second compression ratio.

In step S16, a difference between the first and the second compression ratios is assigned to a change of the exhaust gas temperature, e.g., with the aid of a predefined characteristic diagram or a predefined exhaust gas temperature change minimum value, which defines a minimum change of the exhaust gas temperature to be expected when the compression ratio is changed by more than a predetermined amount (difference, quotient).

If it is established in step S17 that the difference between the measured exhaust gas temperatures is less than the predefined exhaust gas temperature change minimum value (alternative: yes), an erroneous compression setting may be diagnosed and this is accordingly signaled in step S18 as an error of VCR actuator 6. Otherwise (alternative: no), the method steps back to step S1.

The diagnostic methods may be carried out as active diagnoses, the compression ratio being changed regularly, periodically or at predefined points in time corresponding to the requirements of the diagnostic method. Alternatively, the diagnostic method or methods may also be carried out as passive diagnoses, a change of the compression ratio caused by the engine control unit being used for carrying out a diagnosis.

As an alternative for checking the proper functioning of VCR actuator 6 using the exhaust gas temperature, a check may be carried out using other engine variables influenced as a function of compression such as, for example, an integral component of a PID idle regulator. The integral component of the idling actuator may change as a function of the engine drag torque. The drag torque may be influenced by the compression ratio and the consequently changed compression work.

1-11. (canceled).

12. A method for diagnosing a variable setting of a compression ratio in a reciprocating internal combustion engine, the method comprising:
signaling an error of the variable setting of the compression ratio as a function of a measured exhaust gas state variable of the exhaust discharge system.

13. The method of claim 12, further comprising:
measuring the exhaust gas state variable in a determined or instantaneous compression ratio in a predefined operating state;
modeling the exhaust gas state variable for the determined or instantaneous compression ratio in the predefined operating state; and
signaling the error of the variable setting of the compression ratio as a function of a difference between the measured exhaust gas state variable and the modeled exhaust gas state variable.

14. The method of claim 13, wherein the exhaust gas state variable corresponds to an exhaust gas temperature, wherein the exhaust gas temperature is modeled for the determined or instantaneous compression ratio in the predefined operating state based on a predefined exhaust gas temperature model, the exhaust gas temperature model including at least one of the following parameters as input variables:
an ignition angle or an ignition point;
an engine speed;
an air charge;
an air-fuel ratio in the cylinders of the internal combustion engine;
an exhaust gas mass flow;
an ambient temperature;
an ambient pressure;
a cooling rate of the exhaust gas between exit from the exhaust valve and the temperature sensor; and
the determined or instantaneous compression ratio.

15. The method of claim 12, further comprising:
measuring the exhaust gas state variables measured at a predefined first compression ratio and a predefined second compression ratio;
ascertaining a difference between the measured exhaust gas state variables; and
signaling the error of the variable setting of the compression ratio as a function of the ascertained difference between the measured exhaust gas state variables.

16. The method of claim 15, wherein the measured exhaust gas state variable corresponds to an exhaust gas temperature of the combustion exhaust gas in the exhaust discharge system.

17. The method of claim 12, wherein the measured exhaust gas state variable corresponds to a lambda value of the combustion exhaust gas in the exhaust discharge system.

18. The method of claim 12, wherein the method is carried out if release conditions are satisfied, the release conditions including at least one of the following:
the temperature of the internal combustion engine is higher than a predefined threshold temperature;
the internal combustion engine is operated at a predefined operating point or in a predefined operating range, the operating point, in particular, being predefined by a certain speed and/or engine load or the operating range, in particular, being predefined by a certain speed range and/or engine load range;
the internal combustion engine is operated at a static operating point;
the VCR actuator is ready for operation, and
the temperature sensor is ready for operation.

19. A device for diagnosing a variable setting of a compression ratio in a reciprocating internal combustion engine, comprising:
a diagnosing arrangement configured for diagnosing the variable setting of the compression ratio in the reciprocating internal combustion engine, by performing the following:
signaling an error of the variable setting of the compression ratio as a function of a measured exhaust gas state variable of the exhaust discharge system.

20. An engine system, comprising:
an internal combustion engine, including:
a VCR actuator; and
a device for diagnosing a variable setting of a compression ratio in a reciprocating internal combustion engine, including:
a diagnosing arrangement configured for diagnosing the variable setting of the compression ratio in the reciprocating internal combustion engine, by performing the following:
signaling an error of the variable setting of the compression ratio as a function of a measured exhaust gas state variable of the exhaust discharge system.

21. A computer readable medium having a computer program, which is executable by a processor, comprising:
a program code arrangement having program code for diagnosing a variable setting of a compression ratio in a reciprocating internal combustion engine, by performing the following:
signaling an error of the variable setting of the compression ratio as a function of a measured exhaust gas state variable of the exhaust discharge system.

22. The computer readable medium of claim 21, further comprising:
measuring the exhaust gas state variable in a determined or instantaneous compression ratio in a predefined operating state;
modeling the exhaust gas state variable for the determined or instantaneous compression ratio in the predefined operating state; and
signaling the error of the variable setting of the compression ratio as a function of a difference between the measured exhaust gas state variable and the modeled exhaust gas state variable.
